(19) United States
(12) Patent Application Publication
(10) Pub. No.: US 2021/0239817 A1
(43) Pub. Date: Aug. 5, 2021

(54) METHOD AND DEVICE FOR PROCESSING AN ULTRASONIC SIGNAL RECORDED BY AN ULTRASONIC SENSOR

(71) Applicant: Robert Bosch GmbH, Stuttgart (DE)

(72) Inventors: Simon Weissenmayer, Flein (DE); Michael Schumann, Stuttgart (DE)

(21) Appl. No.: 17/049,945

(22) PCT Filed: Apr. 25, 2019
(86) PCT No.: PCT/EP2019/060631

§ 371 Date: Oct. 22, 2020

(30) Foreign Application Priority Data
May 2, 2018 (DE) 10 2018 206 702.3

(51) Int. Cl. G01S 7/527; G01S 15/931

(52) U.S. Cl. CPC G01S 7/527; G01S 2007/52012; G01S 15/931

(57) ABSTRACT

A method for processing a receive signal recorded by an ultrasonic sensor. Echoes are filtered out from a signal curve of the receive signal using at least one echo criterion in order to obtain a filtered receive signal. At least one noise level of the filtered receive signal is determined in at least one subregion of the signal curve.

### FIELD

The present invention relates to a method and to a device for processing an ultrasonic signal recorded by an ultrasonic sensor.

### BACKGROUND INFORMATION

An ultrasonic sensor emits ultrasound. After the emission, the ultrasonic sensor is capable of receiving during a receive window, and records reflected echoes and foreign noises in a receive signal. At the end of the receive window, an intensity of the foreign noises is acquired and is represented in a noise level.

### SUMMARY

The present invention provides a method for processing an ultrasonic signal recorded by an ultrasonic sensor, and a device for processing an ultrasonic signal recorded by an ultrasonic sensor, as well as a corresponding computer program product and a machine-readable storage medium. Advantageous developments and improvements of example embodiments of the present invention described herein result from the description herein.

Specific embodiments of the present invention can advantageously make it possible to acquire ambient noises using an ultrasonic sensor of a vehicle, and to draw inferences concerning events and conditions in the surrounding environment of the vehicle on the basis of the ambient noises.

In accordance with an example embodiment of the present invention, a method is provided for processing a receive signal recorded by an ultrasonic sensor in which echoes are filtered out from a signal curve of the receive signal using at least one echo criterion in order to obtain a filtered receive signal, at least one noise level of the filtered receive signal being determined in at least a subregion of the signal curve.

Features and improvements relating to specific embodiments of the present invention can be regarded as based on, inter alia, the concepts and findings described herein.

In accordance with an example embodiment of the present invention, around waves arriving within a receive frequency range of an ultrasonic sensor excite a transducer of the ultrasonic sensor to oscillations. These oscillations are represented in an electrical receive signal of the ultrasonic sensor. A signal curve of the receive signal represents a time curve of an intensity of the oscillations. The sound waves can be echoes of previously emitted ultrasonic impulses from objects in a region of acquisition of the ultrasonic sensor. However, the sound waves can also come from other noise sources in a surrounding environment of the ultrasonic sensor, such as a contact area of tires of a vehicle with a roadway surface, or wind noises at the vehicle. The sound waves can also be produced by other vehicles.

Echoes are represented as local intensity peaks in the signal curve. Compared to the other noises represented in the signal curve, the echoes can be recognized from the surrounding environment and noise portions using at least one echo criterion. An echo criterion represents a known feature of an echo. The echo criterion can for example be a frequency of the echo. Because the ultrasonic impulses are sent out in a defined frequency range, the echoes are in a similar frequency range. The echo criterion can also be an exceeding of a threshold value formed from an instantaneous oscillation intensity at the transducer. If the echo has a higher intensity than the threshold value, it is recognized as an echo. The echo criterion can also be an expected duration of the echo. A duration of the emitted ultrasonic impulses is known. Therefore, the echo will have substantially the same duration as the ultrasonic impulse that caused it. By applying the at least one echo criterion, a subregion of the signal curve can be recognized as an echo and can be masked, or ignored. If a plurality of echoes are recognized, a plurality of subregions of the signal curve can be masked.

A noise level is formed within a time period of observation, from the intensities of the signal curve. The time period of observation can be variable. Due to the filtering out of the echoes from the signal curve, the noise level is not influenced by the higher intensity of the echoes. A plurality of noise levels can be determined via the signal curve.

The noise level can be determined temporally after an echo represented in the signal curve. After an echo, the signal curve substantially represents only the additionally received noises. In addition, an expected intensity of the echo decreases strongly with a runtime of the echo, and thus with a distance from a reflecting object. After the last recognized echo, possible further weak echoes do not substantially influence the noise level.

The noise level can be determined between the echo and an end of a measurement window of the signal curve. Up to now, the noise level has been determined at the end of the measurement window over a fixed time period. Due to the use of at least a part of the segment between the echo and the end, the noise level can be determined over a longer time period with a higher degree of accuracy.

In an initial region of the signal curve, a ground echo can be filtered out from the signal curve. The noise level can be determined from the signal curve between the ground echo and the echo. A ground echo is made up of echoes from uneven parts of the roadway surface. The echoes of the ground echo have a low intensity, because the uneven parts have a small reflecting surface. Due to the low intensity, the ground echo is acquired only from a small distance from the ultrasonic sensor. The small distance corresponds to a short runtime until the echoes are received at the ultrasonic sensor. The ground echo is acquired in a runtime range that begins shortly after the emission of the ultrasonic impulses. Because the actual echoes from larger objects are filtered out from the signal curve, the noise level can also be determined between the ground echo and the first actual echo.

A plurality of noise levels can also be determined in a plurality of subregions of the signal curve. Thus, the noise, unused up to now, of the receive signal can be used in large portions in order to obtain information about the noises from the surrounding environment represented in the signal curve.

The noise level can be determined as a median value of a plurality of noise level values. The largest noise level value and/or the smallest noise level value of the subregion can be discarded. The noise level can be averaged. Through the elimination of extreme values, outliers can be prevented. A maximum noise level value may represent for example an echo having a smaller intensity than the threshold value.

A noise level value can be determined as the median value of a group of a plurality of successive sensor values of the receive signal. The largest sensor value of the group and/or the smallest sensor value of the group can be discarded. A sensor value can be an average value of a time unit. Through multiple, staggered median formation, a noise level can be produced that, given noises from the surrounding environment that remain approximately the same, remains substantially constant even over a plurality of measurement cycles. However, changes in the noises are reliably represented in the noise level.

The receive signal can in addition be filtered using a decay criterion in order to filter out a decay of an excitation of the ultrasonic sensor from the receive signal after the sending out of an ultrasonic impulse. The transducer of the ultrasonic sensor continues to oscillate after excitation by an electrical signal until the oscillation has been dampened by internal damping of the transducer. The internal damping is known and is represented in the decay criterion. As a result, subsequent post-oscillations of the ultrasonic sensor are not interpreted as noise from the surrounding environment. The decay can be calculated from the intensities of the signal curve. In this way, noises during the decaying can also be represented in the noise level.

The example method according to the present invention can be implemented in software or hardware, or in a mixed form of software and hardware, for example in a control device.

In addition, the present invention provides a device that is designed to carry out, control, or realize the steps of a variant of the method presented here in corresponding devices.

The device can be an electrical apparatus having at least one computing unit for processing signals or data, at least one storage unit for storing signals or data, and at least one interface and/or a communication interface for reading in or outputting data that are embedded in a communication protocol. The computing unit can be for example a signal processor, a so-called system ASIC, or a microcontroller for processing sensor signals and outputting data signals as a function of the sensor signals. The storage unit can be for example a flash memory, an EPROM, or a magnetic storage unit. The interface can be realized as a sensor interface for reading in the sensor signals from a sensor and/or as an actuator interface for outputting the data signals and/or control signals to an actuator. The communication interface can be designed to read in or to output the data in wireless fashion and/or in wire-bound fashion. The interfaces can also be software modules present for example on a microcontroller alongside other software modules.

In accordance with the present invention, also advantageous is a computer program product, or computer program, having program code that can be stored on a machine-readable carrier or storage medium such as a semiconductor memory, a hard drive, or an optical memory, and is used to carry out, implement, and/or control the steps of the method according to one of the specific embodiments described above, in particular when the program product or program is executed on a computer or a device.

It is to be noted that some of the possible features and advantages of the present invention are described herein with reference to various specific embodiments. The person skilled in the art will recognize that the features of the method and of the device can be combined, adapted, or exchanged in a suitable manner in order to arrive at further specific embodiments of the present invention.

### BRIEF DESCRIPTION OF THE DRAWINGS

Below, specific embodiments of the present invention are described with reference to the figures; neither the figures nor the description herein are to be interpreted as limiting the present invention.

FIG. 1 shows a representation of a vehicle having a device according to an exemplary embodiment.

FIG. 2 shows a signal curve of a receive signal having subregions for determining noise levels, according to an exemplary embodiment.

### DETAILED DESCRIPTION OF EXAMPLE EMBODIMENTS

The Figures are merely schematic, and are not to scale. Identical reference characters in the Figures designate identical features, or features having identical function.

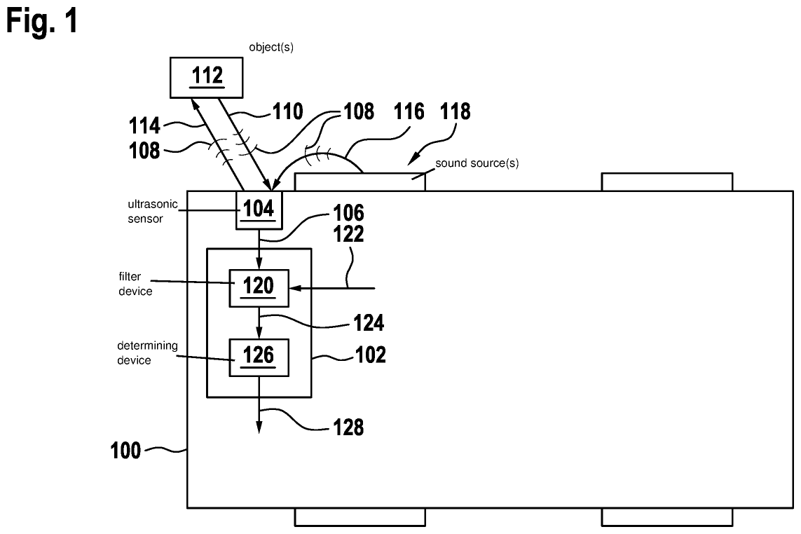

FIG. 1 shows a representation of a vehicle 100 having a device 102 according to an exemplary embodiment of the present invention. Device 102 is designed to carry out a method according to the approach presented here for processing a receive signal 106 recorded by an ultrasonic sensor 104. A signal curve of receive signal 106 represents a time curve of sound waves 108 arriving at ultrasonic sensor 104. Here, in receive signal 106 both echoes 110 of ultrasonic impulses 114 reflected by objects 112 in an area of acquisition of ultrasonic sensor 104 and also noises 116 from other sound sources 118 are represented. Ultrasonic sensor 104 can acquire frequencies within a prespecified frequency range. If noises 116 include frequencies outside the frequency range, these are not represented, or are represented only weakly, in receive signal 106.

In a filter device 120 of device 102, echoes 110 are recognized using at least one echo criterion 122 and are filtered out from the signal curve of receive signal 106. A filtered receive signal 124 is used in a determining device 126 of device 102 in order to determine at least one noise level 128 of at least one subregion of the filtered receive signal 124. Noise level 128 here represents an intensity of noises 116.

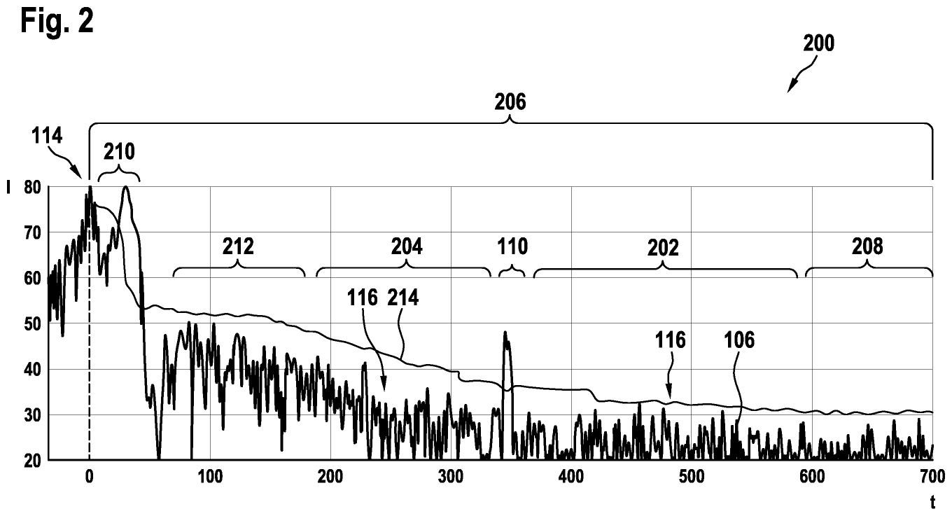

FIG. 2 shows a signal curve 200 of a receive signal 106 having subregions 202, 204 for determining noise levels according to an exemplary embodiment of the present invention. Here, receive signal 106 substantially corresponds to the receive signal shown in FIG. 1. Signal curve 200 is shown in a diagram in which time is plotted on the abscissa and an intensity is plotted on the ordinate. The intensity corresponds to an electrical voltage that can be picked off at the ultrasonic sensor. At a time to, the ultrasonic sensor sends out an ultrasonic impulse 114. With this, a measurement window 206 begins, and shortly before the end of this window, in a specified region 208, the noise level for this measurement window 206 is typically acquired.

For a decay duration 210 immediately after the emission, the oscillation of the ultrasonic sensor continues, and is represented in signal curve 200. During the decay duration, the ultrasonic sensor oscillates with an intensity that is so high that it cannot acquire incoming noises. Therefore, in an exemplary embodiment the decay duration is filtered out from signal curve 200 in order to obtain the filtered receive signal. The decay duration can for example be recognized in the intensity. Oscillations having a higher intensity than a decay value can be filtered out.

Shortly after decay duration 210, the first echoes are received at the ultrasonic sensor. The first echoes represent a ground echo 212. Ground echo 212 is made up of a multiplicity of individual echoes, received one after the other, of ultrasonic impulse 114, reflected by uneven parts of the roadway surface. Ground echo 212 is not represented as a single strong echo in signal curve 200, because the roadway surface is oriented approximately parallel to a direction of propagation of ultrasonic impulse 114. Close to the ultrasonic sensor, ultrasonic impulse 114 has a high amplitude. Therefore, the first echoes of ground echo 212 have a relatively high intensity. The intensity of the echoes decreases over time. The more roughly the roadway surface is structured, the stronger ground echo 212 is.

Up until the reception of a hard echo 110, here further time passes in which the intensity of receive signal 106 further decays. In receive signal 106, weakening ground echoes and noises 116 are superposed. Here, the intensities influence a threshold value 214 that can be used as an echo criterion. If signal curve 200 exceeds threshold value 214, echo 110 is recognized. A time region around echo 110 is filtered out from signal curve 200 in order to obtain the filtered receive signal.

After echo 110 and until the end of measurement window 206, further noises 116 are represented in signal curve 200.

In the approach presented here, subregion 202 of signal curve 200 after echo 110, and/or the subregion between ground echo 212 and echo 110, is used to determine at least one noise level.

In other words, an improved noise level measurement, for an optimized determination of the road condition, is presented.

The ultrasonic sensors determine the noise level in the final seven milliseconds of a measurement window 206. Through the determination in this region, it is ensured that possible echoes 110 from objects that are so far away that they are no longer perceptible, and thus do not play a role in the determination of the background noise, reach the sensor.

On the basis of the noise level of the ultrasonic sensors, a road condition can be ascertained. In order to enable reliable recognition of short puddles or short damp places, even at high vehicle speed, it is necessary for the noise level to be capable of being acquired at the highest possible frequency and with the highest possible quality.

Through the approach presented here, the signal quality of the measured noise levels is improved in order to enable better determination of the road condition.

The noise level is ascertained not only using the sensor values of the last seven milliseconds, but also in the range in which echoes 110 can be received, the signals being used to calculate the noise level only if an influence by echoes 110 can be excluded, or if the influence of echoes 110 can be compensated.

The signals of the ultrasonic sensors are coded. This means that the frequency is not held constant during emission, but rather changes. Thus, for example at a frequency of 55 kHz the emission begins, and during the emission the frequency is lowered to 45 kHz. The sensors check whether echoes 110 also correspond to this coding. The better the received echoes 110 correspond to this coding, the higher the probability is that the receive signal originates from an echo 110, and the lower the probability that the receive signal is to be attributed to noise caused by ambient noises. In addition, a dynamic threshold 214 is calculated on the basis of the surrounding measurement values. If the signal increases past this dynamic threshold 214, that is also an indication that an echo 110 from an object has been received. If an echo 110 is received with some probability, then a broadly selected range around received echo 110 is not used for the calculation of the optimized noise level.

FIG. 2 shows a measurement in which an echo 110 from an object is received between subregions 202, 204.

The noise level can be determined within subregions 202, 204 as follows:

In the first subregion 202 between the final echo 110 and the region 208, in which the noise level is standardly calculated, a further noise level is calculated. This is calculated similar to the standard noise level. The average measured voltage value is taken of each millisecond. From a packet of seven average voltage values, the two largest are discarded, and from the five remaining a median value is calculated. Starting from the region 208, noise levels of complete packets are calculated up until the last recognized object, or, if no object has been recognized, up to a distance from which the influence of the clutter level, or ground echoes 212, becomes negligible. In the depicted example, the clutter level becomes negligible at the same location at which the object is recognized. From the noise levels of all packets, and from the noise level of region 208, two of seven levels are discarded, and from the remaining levels another median value is calculated.

In an exemplary embodiment of the present invention, the noise levels of packets in second subregion 204 are also calculated, and their noise levels are included in the median value calculation over all packets. The closer the calculated noise level of a packet is to ground echoes 212, the higher the influences of the clutter level are on the noise level. In the region of ground echoes 212, with the aid of the home or cross-echo, the condition of the roadway surface is measured. In general, the following holds: the lower the clutter level, the smoother the roadway surface. However, the influence of the roadway surface, or of the echoes and cross-echoes, goes far beyond the region marked here as ground echoes 212, but decreases as the distance becomes larger. In the example, the influence of the clutter level extends over the complete second subregion 204. For this reason, it can be advantageous if this influence is compensated. This can be done as follows: calculating the noise level from all packets of first subregion 202 and region 208, calculating the clutter level, and calculating an expected level through interpolation as a function of the position between the end of the region of ground echoes 212 and the beginning of first subregion 202 and the previously calculated values. There then subsequently takes place a correction of the noise level of the respective packet, using a quotient of the calculated expected level and the calculated noise level.

In certain operating states, the emission frequency can be reduced, or the emission can be completely omitted. If, within a complete measurement, echoes are to be expected neither from the home sensor nor from adjacent sensors, then the complete measurement can be used for the calculation of a noise level.

The control device can determine the signal quality of the noise level, calculated in optimized fashion, by taking into account whether the calculation of echoes 110 was influenced, or could have been influenced. The signal quality is best when no ultrasonic echoes are to be expected in the measurement, and no echoes 110 were recognizable. The signal quality is worse if echoes 110 or cross-echoes are to be expected, because the sensor itself, or adjacent sensors, has made emissions even if no echoes 110 have been recognized. If echoes 110 are to be expected and a large number of echoes 110 from objects at a great distance are recognized, then the signal quality is at its poorest. With the aid of the signal quality, the control device can calculate how strongly the measurement of the noise level should enter into the calculation of the road condition. The better the signal quality, the greater the influence.

The expanded calculations of the noise level can be carried out either in the microcontroller of the control device—if the sensor is supposed to send the raw signals to the control device—or directly in the ASIC of the sensor. Ideally, the sensor sends both the noise level calculated within region 208, and also additionally sends the noise level calculated in optimized fashion via the at least one further part of the measurement, to the control device.

Through the approach presented here, the road conditions, weather influences, and interference sources can be better distinguished from one another. Short damp, wet, or flooded roadway segments can be recognized more reliably. The condition of the tires can be better determined. Wind and wind direction can be better determined.

Finally, it is to be noted that terms such as “comprising,” “including,” etc., do not exclude any other elements or steps, and terms such as “one” or “a” do not exclude the presence of a plurality.

1-10. (canceled)

11. A method for processing a receive signal recorded by an ultrasonic sensor, comprising the following steps:
filtering out echoes from a signal curve of the receive signal using at least one echo criterion to obtain a filtered receive signal; and
determining at least one noise level of the filtered receive signal in at least one subregion of the signal curve.

12. The method as recited in claim 11, wherein the noise level is determined temporally after an echo represented in the signal curve.

13. The method as recited in claim 12, wherein the noise level is determined between the echo and an end of a measurement window of the signal curve.

14. The method as recited in claim 12, wherein, in an initial region of the signal curve, a ground echo is filtered out from the signal curve, and the noise level is determined from the signal curve between the ground echo and the echo.

15. The method as recited claim 11, wherein the noise level is determined as median value of a plurality of noise level values, a largest noise level value and/or a smallest noise level value of the subregion being discarded.

16. The method as recited in claim 15, wherein a noise level value is determined as median value of a group of a plurality of successive sensor values of the receive signal, a largest sensor value of the group and/or a smallest sensor value of the group being discarded.

17. The method as recited in claim 11, wherein the receive signal is filtered using a decay criterion to filter a decay of an excitation of the ultrasonic sensor out of the receive signal after emission of an ultrasonic impulse.

18. A device configured to process a receive signal recorded by an ultrasonic sensor, the device configured to:
filter out echoes from a signal curve of the receive signal using at least one echo criterion to obtain a filtered receive signal; and
determine at least one noise level of the filtered receive signal in at least one subregion of the signal curve.

19. A non-transitory machine-readable storage medium on which is stored a computer program for processing a receive signal recorded by an ultrasonic sensor, the computer program, when executed by a computer, causing the computer to perform the following steps:
filtering out echoes from a signal curve of the receive signal using at least one echo criterion to obtain a filtered receive signal; and
determining at least one noise level of the filtered receive signal in at least one subregion of the signal curve.
